(19) United States
(12) Patent Application Publication
(10) Pub. No.: US 2017/0214753 A1
(43) Pub. Date: Jul. 27, 2017

(54) VEHICLE ENTHUSIAST COMMUNICATION SYSTEM AND METHOD

(71) Applicant: Adrian Sandoval, Fort Polk, LA (US)

(72) Inventor: Adrian Sandoval, Fort Polk, LA (US)

(21) Appl. No.: 15/414,446

(22) Filed: Jan. 24, 2017

Related U.S. Application Data
(60) Provisional application No. 62/287,160, filed on Jan. 26, 2016.

(51) Int. Cl. H04L 29/08; G06F 17/30; G07C 5/00; H04W 4/02

(52) U.S. Cl. CPC H04L 67/18; H04W 4/023; G06F 17/30241; G06F 17/3097; H04L 67/26; G07C 5/008

(57) ABSTRACT

A vehicular based logistical system having a mobile device connected to one or more wireless networks, wherein a user engages the mobile device to establish a vehicle profile. One or more remote servers are in communication with the mobile device. An information request established on the mobile device is transmitted over a wireless network to the one or more remote servers, wherein the one or more remote servers compiles responsive data, wherein the remote servers establishes a subsequent transmission scheme to forward the data to the mobile device.

### CROSS-REFERENCE TO RELATED APPLICATION(S)

The present application claims priority to U.S. Provisional Patent Application No. 62/287,160 filed on Jan. 26, 2016, entitled “Car Enthusiast System” the entire disclosure of which is incorporated by reference herein.

### BACKGROUND OF THE INVENTION

1. Field of Invention

The present invention relates to the field of communication and logistics. In particular, communication and logistical systems relating to communities of common interest.

2. Description of Related Art

People travel all over to attend events catering to vehicle enthusiast such as car, on and off-road motorsport, watercraft, and performance modification enthusiasts. When locating these events, venue information including location and dates, must be established and verified before someone will invest their time into traveling and attending an event.

Generally, a search of the Internet is performed to find the information that is then transcribed by the individual for planning the logistics of the trip. When the event is among local groups or friends, communication through telephone calls and text messaging is done on a very specific person-to-person basis limited by the ascertainable individuals of the group. During these events of meet-ups it is inevitable that another platform must be used to locate the venue, service stations, and previously agreed upon stops.

Vehicle data information is often difficult to deduce from a visual inspection and a vehicle owner may not always be forthcoming or honest. When separating vehicles for various events based on class, this data is important in forming the categories and proper vehicle placement. In racing, it is often the goal of participants to establish fair standards for setting up a race. This information is easily concealed or inaccurate when the only source available is the vehicle owner.

Based on the foregoing, there is a need in the art for a single system that will allow for an aggregation of data, location services, event information, hosting capability, and verification of vehicle data without relying on unverified information or multiple cumbersome platforms that cause dangerous situations while operating a motor vehicle.

### SUMMARY OF THE INVENTION

In an embodiment, a vehicular-based logistical system has a mobile device connected to one or more wireless networks, wherein a user engages the mobile device to establish a vehicle profile. One or more remote servers are in communication with the mobile device. an information request is established on the mobile device, and the information request is transmitted over a wireless network to the one or more remote servers, wherein the one or more remote servers compiles responsive data, wherein the remote servers establishes a subsequent transmission scheme to forward the data to the mobile device.

In an embodiment, the information request is based on the vehicle profile, and wherein the information request further comprises one or more user inputs.

In an embodiment, the information request is established using a method comprising the steps of the user inputting data into the system through the mobile device, wherein the data comprises at least a geographical location and one or more vehicle attributes. Next, the system displaying one or more suggestions to the user through a display of the mobile device, wherein the one or more suggestions are based on the vehicle profile and the geographical location. Then, the user confirming the information to be sent and the mobile device sending the information request across the wireless network.

In an embodiment, the one or more remote servers are remote mobile devices, wherein the remote mobile devices receive the information request.

In an embodiment, the subsequent transmission scheme is a schedule for data transmission from the one or more remote servers to the mobile device, wherein the schedule is determined through a method comprising the steps of the one or more remote servers analyzing the information request for at least a unique identifier, one or more predetermined keywords, or predetermined vehicle attributes. Then, the one or more remote servers compiling data based on the information request. Then, the one or more remote servers updating the compiled data, wherein the update is based on elapsed time from receipt of the information request.

In an embodiment, the elapsed time is continuous.

In an embodiment, the elapsed time is periodic, and wherein a frequency is predetermined.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow diagram of the vehicle enthusiast system and method, according to an embodiment of the present invention;

### DETAILED DESCRIPTION OF PREFERRED EMBODIMENTS

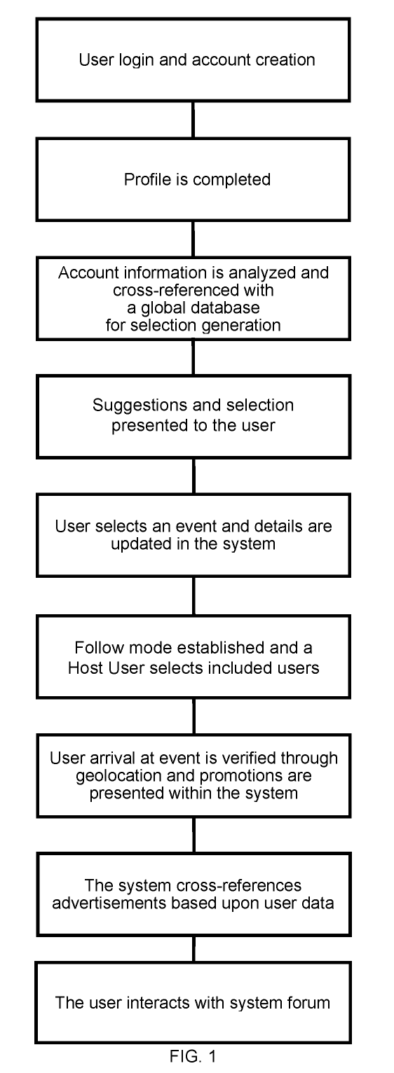

Preferred embodiments of the present invention and their advantages may be understood by referring to FIG. 1, wherein like reference numerals refer to like elements.

In step 10 the user logs in to the system or creates an account. In step 15 a profile is completed with the interests of the user with respect to vehicles, such as cars, trucks, off-road vehicles, motorcycles and watercraft, and vehicle-related events, shows, conferences and meet-ups. The user's typical location and current location (which is periodically updated) are also added to the profile. The user may also specify in preferences what types of communication that user would like to receive or not receive. In step 20 the application cross-references the interests of the user with a global database of vehicle-related shows and provides the user with several selections based on proximity to the user and relatedness to the user's preferred vehicle type/event type. In an embodiment, each event is shown alongside a registered user tally to show the number of user registered for an event.

In step 25 the user is presented with a screen showing events coming up within a specified timeframe. In an embodiment, a calendar is shown on the screen with the events highlighted according to date and location, and in particular events that the user has selected or expressed an interest in. Updates to the events are also shown, such as changes of location and time. In an embodiment, events are created or established by a user where the user may act as the host for the event. Forum style communication, with media upload capabilities, allows users to communicate information to one another. The posts may be linked to the user account for facilitated upload of pictures, video, and information. In step 30, in an embodiment, the user may select an event near the event time and the directions are shown onscreen from the user's present location to the event. Global positioning system (GPS) functionality allows the system to geolocate a user and relates location information to the user. In an embodiment, the GPS function interfaces with existing mapping systems. In step 35, the user may select another user to “follow”, wherein the other user's location is determined and real-time directions are provided to the other user's location. The other user may set in preferences whether or not their location may be followed. In an embodiment, the host can see who is tracking them through the follow function. The interaction among users in the follow function and other modes may allow for the ability to block-out or exclude people from groups or specific functions. The system identifies a mobile device associated with a specific user for acute interaction control. In particular a police lockout mode may be engaged to prevent location being shared with the police and notifies the user of known police locations. In step 40, the user attends the event and receives real-time promotions while at the event, and subsequent coupons or prizes based on the user's expressed interests.

In step 45 the system cross-references ads related to the user's interests and locations, and provides the ad within the screen view of the system. In step 50, the user is provided with a forum to share ideas on the vehicle interests of his or her choice with other like-interested individuals. In the forum, users may buy, sell, and trade cars and car parts, or advertise cars for sale, as well as sharing pictures and videos of vehicles of interest to the user.

In an embodiment, forums or sections of the system are segments into one or more categories based on vehicle type. These categories can include one or more subcategories that are selected by a user, whereby the selection are stored and associated with the user profile. For example, if the user selects a groups of vehicles relating to aircraft, subcategories may include: personal aircraft, commercial aircraft, or specific subcategories or either. Likewise, an example of the categorical setup relating to cars is main categories or cars or trucks. Subcategories could include low-riders, imports, all-wheel drives; gymkhana; drag racers; muscle; etc. Trucks may have subcategories including off-road vehicles, 4×4s; 6×6s; mini-trucks; pick-ups; etc. Subcategories of such subcategories may be further divided by specific modifications to the vehicles. For example, the categories and their sub categories could be as follows: (Cars)—tuners, muscle, low riders, electric, hybrid, classic, track car, and any others; (Trucks)—off-road, diesel, lifted, monster truck, low rider, and any others; (Bikes)—muscle, street bike, scooters, 3 wheels, and any; (Off-road)—dirtbike, quad, sandrail, 4×4, and any; (Watercraft)—wave runner, jet ski, boat, and any others; (Aircraft)—cessna planes, small plane, big plane, hover craft, jets, and any others. These categories allow people to understand what kind of meet it is.

In an embodiment, a the system establishes a variety of modes whereby the system interacts with the mobile device to alter GPS functionality, power consumption between the device and the power source, or autonomously communicate with one or more report devices. A tracking mode enables one or more users or one or more mobile devices to be tracked. Route save mode allows one or more tracked GPS locations and routes to be stored within storage of the mobile device. The stored route is recoverable for future analysis whereby the user engages the system to identify a tracked saved route based on location or time for recollection whereby the system presents the tracked route information. An alternative route mode operates as the system is instructed by the user to alter a current route. For example, a leader of a group of users operating within the same route may select the alternate route mode to adjust the GPS direction and location of the leader device while providing instructions for following devices to alter accordingly. A breakup mode is used to quickly disperse or terminate a current and existing route. In the breakup mode, the user engages the system to initiate the breakup mode which will transmit the instructions over a wireless network to one or more remote devices operating within the same route. An emergency mode operates as the system is either instructed of a current emergency situation or whereby the phone identifies an emergency situation based on a deviation of the GPS location of the device from an existing route. In emergency mode, the system locks out unnecessary functionality of the mobile device to conserve power consumption. For example, the backlighting and any other applications operating in the background may be turned off to extend battery life. If the system receives confirmation of an emergency situation from the user or a delay is responding to an emergency situation prompt sent by the system for user review, the system will then send one or more signals to a predetermined individual or individuals. If no individual is predetermined, the system may send a universal signal received by one or more remote devices operating the system within a predetermined distance. In emergency mode, the system may instruct the mobile device to send a signal to one or more emergency responders such as police, fire departments, or emergency medical services. A block-out mode is operated within a unit of the system whereby a user may exclude or block out other user interaction. In an alternative embodiment, block out mode allows one or more unwanted users to be blocked out from access to the system from a remote or local device.

In an embodiment, the system will facilitate a connection between the user and vehicle related services, products, and pricing. Based on the user profile, including location, emergency relief information, car washes, tire shops, mechanics, service stations, automotive shops, performance service stations, tuning shops, salvage yards, gas stations and information on availability of high octane fuel, etc. are displayed to the user along with direction options for a desired destination. In an alternative embodiment, the system has a vendor portal, where a vendor, such as a shop owner, may present specific information about their services, products, and pricing, which is then displayed to nearby users. Categories of a sales forum between vendors or between users may include: engine(s) or engine parts; transmission(s) or transmission parts; wheels and tires; parts; and tools.

In another embodiment, the system operates over one or more wireless networks. The system gathers data from the user profile and the data is transmitted across the network to one or more remote servers. The remote servers receive the data, which is separated therein. The remote server then generates one or more responsive information packets based on the data received. The responsive information is cross referenced with the data received from the user and any specific user request for responsive information. The remote server then transmits the responsive information in a data packet across the wireless network to the local user device. When received on the local device, the data is converted and displayed to the user through the system on the local device. In one or more embodiments, the responsive data comprises a set of subsequent responses to be sent from the remote server to the local device. The schedule for delivery of the subsequent responsive data is established through the initial inquiry or data sent by the user to the remote network. For example, where a user is new to an area, the GPS location will identify a geographic location of the user. Based on the geographic location, the user profile data is compiled and transmitted to one or more remote servers. The one or more remote servers may be a centralized server or remote devices of other users. The data is then use to gather information of local events or nearby users with similar interests based on the initial user profile. Information from the remote servers such as local events, meet up groups, product sales, or services is transmitted to the user's local device where it is displayed for user acceptance. If the user selects an option relating to the length of time they will be in a particular geographic location, the remote server will continuously update or periodically update responsive communications based on the initial transmission of information. The updated information may be configured by the user wherein scheduled subsequent transmissions are controlled by the frequency of which they occur.

Another example of scheduled information exchange refers to meet ups between users. A request may be sent based on user instruction or automatically based on a change in status or location of the device. Local meet ups are presented for user consideration. If the user is aware of a specific event, an inquiry can be prepared including specific user identification information, vehicle information, or any other specific inquiry for the meet up. In another embodiment, the user confirms or declines meet up opportunities. The actions of the user, in this aspect, generates a trend of user interaction with responsive information from the system. The system may then incorporate the trend or history information of user acknowledgement of the responsive communications. For example, if the user continuously selects to attend meet ups involving a particular style of vehicle, the system will establish a trend based on that type of vehicle and may adjust the priority of responsive communications accordingly.

In another embodiment, the user may establish a request for information based on key-word inquiries or profile related inquiries. The system will collect user inputs including specific inputs for the purpose of establishing search parameters. Based on these inputs, the system will transmit information requests over one or more networks. Responsive communications received by the system will be prioritized and forwarded to the user local device for consideration. For example, if the user is specifically interested in legal events surrounding vehicle operation or configurations, the inquiry will be based on the same. The system will then search local and wireless networks for dated information. The resulting information will be organized based on the relevance to the initial inquiry as well as the date of publication or event. The user will then be presented with this information.

In an embodiment, the system has an OBD scanner therein and an OBD or OBD-2 scanner interface cable for engaging with the car's engine control unit. The OBD scanner receives a vehicle profile from the scanner, which may be shared with nearby phones. This may be used in conjunction with the “follow me” feature for vehicle racing. In an embodiment, the OBD device transmits general information about the vehicle including performance data. A user may have the ability to create a vehicle profile and associate the profile with a unique identifier of the OBD device. This information me be transmitted and obtained by other users to verify details about a vehicle. For example, the information may be used to verify the class a vehicle can be considered. In an alternative embodiment, the system interacts with the OBD device remotely. A user may manipulate, control, and delete information contained within the OBD device.

In an alternative embodiment, the OBD device will transmit data of vehicles placed up for sale or vehicles that have had mechanical adjustments made. The information is transmitted to the user through the system and the mobile device, where the user is able to determine certain modification or alterations made to the vehicle.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A vehicular based logistical system comprising:
a. a mobile device connected to one or more wireless networks, wherein a user engages the mobile device to establish a vehicle profile;
b. one or more remote servers in communication with the mobile device; and
c. an information request established on the mobile device, wherein the information request is transmitted over a wireless network to the one or more remote servers, wherein the one or more remote servers compiles responsive data, wherein the remote servers establishes a subsequent transmission scheme to forward the data to the mobile device.

2. The system of claim 1, wherein the information request is based on the vehicle profile, and wherein the information request further comprises one or more user inputs.

3. The system of claim 1, wherein the information request is established using a method comprising the steps of:
a. the user inputting data into the system through the mobile device, wherein the data comprises at least a geographical location and one or more vehicle attributes;
b. the system displaying one or more suggestions to the user through a display of the mobile device, wherein the one or more suggestions are based on the vehicle profile and the geographical location;
c. the user confirming the information to be sent; and
d. the mobile device sending the information request across the wireless network.

4. The system of claim 1, wherein the one or more remote servers are remote mobile devices, wherein the remote mobile devices receive the information request.

5. The system of claim 1, wherein the subsequent transmission scheme is a schedule for data transmission from the one or more remote servers to the mobile device, wherein the schedule is determined through a method comprising the steps of:
a. the one or more remote servers analyzing the information request for at least a unique identifier, one or more predetermined keywords, or predetermined vehicle attributes;
b. the one or more remote servers compiling data based on the information request;
c. the one or more remote servers updating the compiled data, wherein the update is based on elapsed time from receipt of the information request.

6. The system of claim 5, wherein the elapsed time is continuous.

7. The system of claim 5, wherein the elapsed time is periodic, and wherein a frequency is predetermined.
